(19) United States
(12) Patent Application Publication
(10) Pub. No.: US 2022/0188049 A1
(43) Pub. Date: Jun. 16, 2022

(54) DISTRIBUTION OF COLOR SAMPLES

(71) Applicant: Hewlett-Packard Development Company, L.P., Spring, TX (US)

(72) Inventors: Peter Morovic, Sant Cugat del Valles (ES); Juan Miguel Huertas Delgado, Sant Cugat del Valles (ES); Jan Morovic, London (GB)

(73) Assignee: Hewlett-Packard Development Company, L.P., Spring, TX (US)

(21) Appl. No.: 17/417,828

(22) PCT Filed: Sep. 4, 2019
(86) PCT No.: PCT/US2019/049475

§ 371 Date: Jun. 24, 2021

(51) Int. Cl. G06F 3/12

(52) U.S. Cl. CPC G06F 3/1208; G06F 3/1253; G06F 3/1241

(57) ABSTRACT

In an example, a method includes obtaining, at a processor, data indicative of a color of each of a first plurality of generated color samples, wherein the color samples are generated using an initial set of sample generation instructions. It may be determined, by a processor, if a spatial distribution of the colors of the generated color samples corresponds to a predetermined spatial distribution in a first color space. When the spatial distribution of the color of the generated color samples does not correspond to the predetermined spatial distribution, the method may further comprise determining, by a processor, a new sample generation instruction. The new sample generation instruction may replace an initial sample generation instruction in the initial set of sample generation instructions to determine a modified set of sample generation instructions. The new sample generation instruction may be generated to increase a correspondence of the spatial distribution of colors of a second plurality of color samples generated using the modified set of sample generation instructions to the predetermined spatial distribution.

### BACKGROUND

Devices for outputting colors, such as printing devices or display devices, may make use of color mappings between color spaces. For example an image may be displayed on a display using an RGB color space and converted to a CMYK color space for printing. In this example the mapping defines how a point in RGB space is transformed to a point in CMYK space. For some devices the mapping between color spaces may be defined at the time of manufacture of the device, or may be updated during the life of the device.

### BRIEF DESCRIPTION OF DRAWINGS

Non-limiting examples will now be described with reference to the accompanying drawings, in which;

FIG. 1 is a flowchart of an example of a method of determining a new color generation instruction;

FIG. 2 is a flowchart of an example of a method of determining for which color to determine a new sample generation;

FIG. 3 is a schematic drawing of points in a color space;

FIG. 4 is a flowchart of an example of a method of determining a new color generation instruction;

FIGS. 5A and 53 are a schematic drawings of color samples;

FIG. 6 is a schematic drawing of an example machine-readable medium associated with a processor; and

FIG. 7 is a simplified schematic of an example of processing circuitry.

### DETAILED DESCRIPTION

The components of an output device such as a printing device or a display device may change over time, for example due to ageing of the components, resulting in the output color being different from the intended output color. In the case of printing devices, such as inkjet printers, the output color may vary due to the quantity of ink ejected from a nozzle changing as the printhead ages, for example due to accumulated dried ink, or may differ due to the use of a different type of print media. Such changes may be difficult to accurately predict at the time of manufacture as they may depend on factors such as the types of media used, the frequency of use of the device and/or the environmental conditions in which the device is used or stored.

As an output device ages, the changes in the device may cause non-uniformity, such as compression, of a portion of the color gamut of the device (i.e. the colors which may be output), resulting in a loss of color detail in that portion of the gamut.

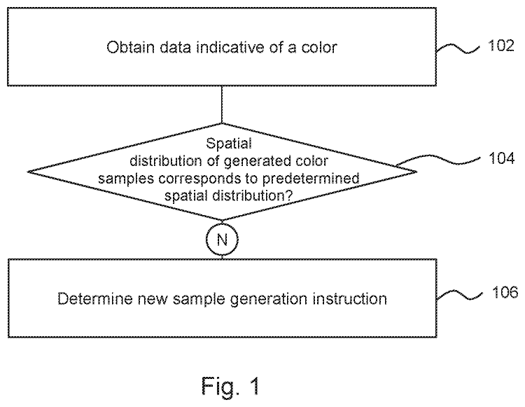

FIG. 1 shows an example of a method, which may be a method of calibrating an output device, for example to compensate with changes in the output thereof over time.

Block 102 comprises obtaining, at a processor, data indicative of a color of each of a first plurality of generated color samples, wherein the color samples are generated using an initial set of sample generation instructions.

The data may for example be obtained by measuring each color sample and/or may be obtained from a memory comprising data corresponding to an earlier measurement, or received over a network or the like. For example, the obtained data may identify a plurality of points in a color space, each point corresponding to a respective color sample. The color samples may be measured using a colorimeter or other device which can output data corresponding to a point in a color space such. An example of such a color space is CIELAB, which describes a color in terms of three values: L* for the lightness, a* from green to red and b* from blue to yellow. Other examples of color spaces include be sRGB, Adobe RGB, Hue-Saturation-Value (HSV), Hue-Saturation-Lightness (HSL), Yule-Nielsen-corrected XYZ, XYZ, LAB or the like.

In this example, the initial set of sample generation instructions are instructions which instruct the output device to generate (e.g. print) the color samples. The initial set of sample generation instruction may include a mapping between color spaces. For example an image may be stored using a color space such as RGB and a printing device may utilise a color space such as CMYK, and data may be mapped from RGB to CMYK for printing. In some examples the mapping is a look-up table. The sample generation instructions may comprise instructions providing, for example, proportional coverages of one or more print materials, and may also be referred to as print instructions.

The generated color samples may be a number of patches of color, for example displayed on a display device or printed on a print media. The generated color samples may be a selection of colors which can be used to characterise the colorimetry of the device. For example they may be representative of the achievable color gamut of the device or may be representative of a portion of the achievable color gamut. Generation of the color samples may be performed as part of a calibration routine, for example at predetermined time intervals, or when the device is instructed to perform a calibration by a user. For example if a user notices a reduction in print quality they may instruct the print device to generate color samples to perform a calibration of that device. Generation of the color samples may be an entirely automated process, for example color samples may be generated to represent the whole gamut. In other examples a user may provide input to the generation of the color samples. For example if a user notices that a particular portion of the color gamut is not reproduced satisfactorily they may initiate a calibration of that portion of the color gamut. In such examples the generated color samples may represent only the portion(s) of the color gamut indicated by the user.

Block 104 comprises determining, by a processor, if the spatial distribution of the colors of the generated color samples corresponds to a predetermined spatial distribution in a first color space. The predetermined spatial distribution may be representative of an intended spatial distribution. For example it may comprise points spaced substantially evenly or uniformly throughout the color space. In an example, a ‘uniform spacing’ in a color space refers to points which are spaced such that the perceptual differences between pairs of adjacent points is at least substantially constant throughout that portion, or all of, the color space.

In other examples the predetermined spatial distribution may comprise a greater density of points in specific locations and a lower density of points in other locations, for example based on the outcome to be achieved and/or the specific color space which is used. For example the CIELAB color space is designed such that the non-linear relationships between L*, a* and b* mimic the non-linear response of the human eye and therefore it may be intended for the predetermined spatial distribution to be uniform when the CIELAB color space is used as the first color space. Conversely for color spaces which do not mimic the perceptual difference perceived by the human eye a non-uniform predetermined spatial distribution may be used,

When it is determined in block 104 that the spatial distribution of the color of the generated color samples does not correspond to the predetermined spatial distribution, the method proceeds to block 106. If the spatial distribution of the generated color samples does correspond to the predetermined spatial distribution it may be determined that the output device does not need further calibration (i.e. the device is behaving as intended). However, if the spatial distribution deviates from the predetermined distribution, this may be indicative that the output does not correspond to the expected output.

Block 106 comprises determining, by a processor, a new sample generation instruction (or more generally, a new print instruction), the new sample generation instruction being to replace an initial sample generation instruction in the initial set of sample generation instructions to determine a modified set of sample generation instructions. The new sample generation instruction is generated to increase the correspondence of the spatial distribution of colors of a second plurality of color samples generated using the modified set of sample generation instructions to the predetermined spatial distribution. For example, if the intended spatial distribution is uniform, then an instruction which resulted in a sample which disrupts the uniformity of the color samples may be replaced with a new instruction which is intended to result in a color sample which increases the uniformity of the color samples as a whole.

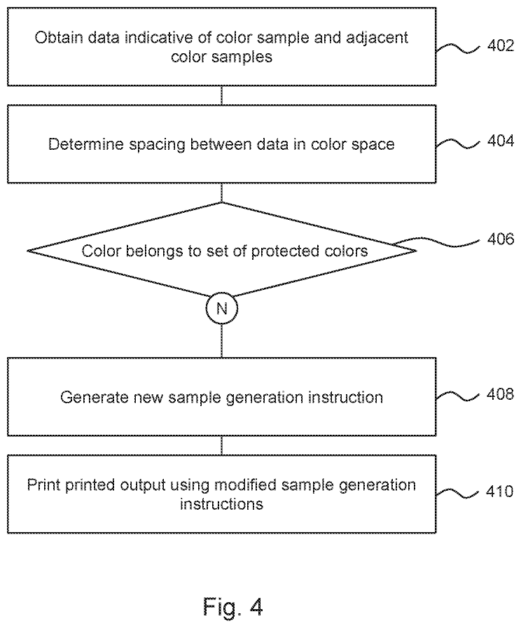

The new sample generation instruction may be based on the obtained data indicative of the color of each of a first plurality of generated color samples. In particular, the new sample generation instruction may be determined by considering the obtained data corresponding to the initial sample generation instruction. An example of generation of the new sample generation instruction is described in more detail in relation to FIG. 4. The new sample generation instructions may replace sample generation instructions, or more generally provide a print instruction in a color mapping resource which may be used for printing samples and any other printed outputs. It may be noted that, generally herein, a sample generation instruction may be synonymous with a print instructions, for example for printing a color, for example providing a proportional coverage for each of a plurality of printing materials.

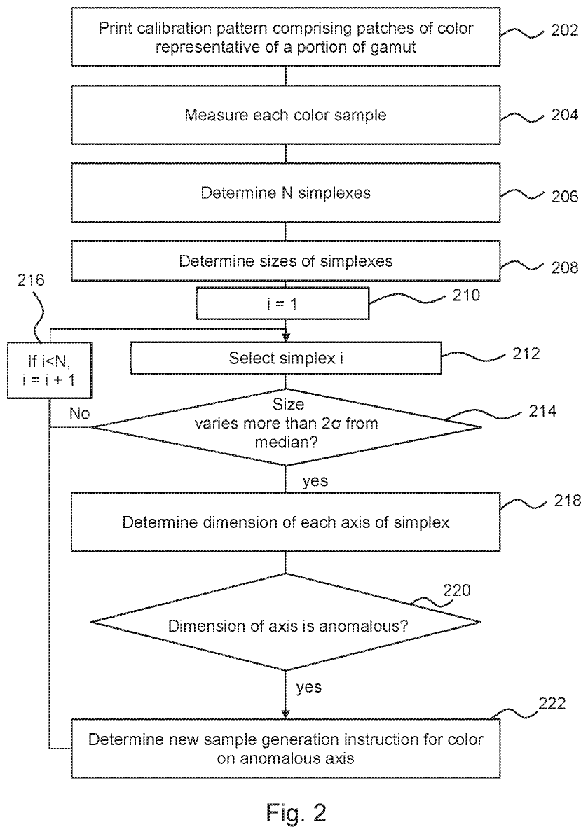

FIG. 2 is an example of a method, which may be a method of calibrating an output device including a method for determining which sample generation instruction is to be replaced.

Blocks 202 and 204 are an example of obtaining data indicative of a color for example as referred to in relation to block 102 of FIG. 1. Block 202 comprises printing a calibration pattern comprising each of the first plurality of generated color samples. In this example the printed calibration pattern comprises printing patches of color representative of a portion of a gamut of a printing apparatus. The user may provide input, or select, the portion of the gamut represented by the patches if they believe that portion may benefit from calibration.

Block 204 comprises measuring each color sample in the printed calibration pattern to obtain the data. Measuring the color samples may be performed by the output apparatus, for example using an integrated sensor such as an ‘inline scanner’ of a print apparatus, or by another device such as a colorimeter. The apparatus used to perform the measuring may output data characterising a point in a color space corresponding to each color sample measured.

In this example, the predetermined spatial distribution is a uniform distribution, and determining if the spatial distribution of the colors of the generated color samples corresponds to the predetermined spatial distribution comprises determining a measure describing a spatial uniformity of the data indicative of colors of the first plurality of generated color samples and identifying at least one outlier in the determined measure. If a new sample generation instruction is generated, it is generated for a color sample associated with a region of color space including an identified outlier in the determined measure.

In this example the measure describing spatial uniformity is determined in blocks 206 and 208. Block 206 comprises determining a plurality of simplexes in the first color space. The vertices of the simplexes are provided by the obtained data indicative of the color of each of the first plurality of generated color samples. In other words, in this example, each color sample provides a vertex, and the space is tessellated by linking pairs of vertices to provide simplexes (i.e. polygons or polytopes in color space which fill the space between the vertices completely without overlaps or gaps). In this example, the number of simplexes determined is N.

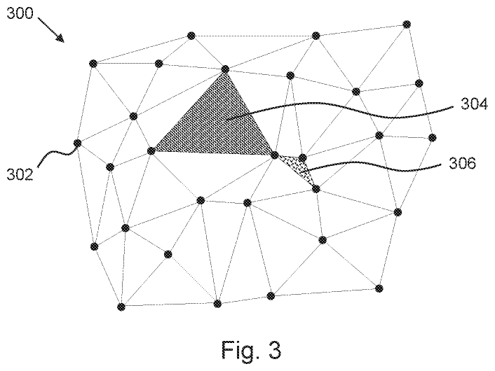

Block 208 comprises determining a size of each simplex, wherein the measure describing spatial uniformity is the determined size. An example of determining a plurality of simplexes and determining their size is described in more detail in relation to FIG. 3.

In this example, each simplex is considered in turn. In block 210, a simplex index i is set to 1 and in block 212 simplex i is selected for inspection.

In this example, identifying an outlier comprises identifying when the determined measure significantly deviates from an expected value. In particular, in block 214, an outlier is determined in this example by identifying when the size varies more than two standard deviations from a median of the size (e.g. area or volume) of the set of simplexes. In another example, determining an outlier may comprise identifying when the size varies by more than one standard deviations from a median of the sizes of the set of simplexes, or another value (which may be a non-integer value (based on the standard deviation. In another example, determining an outlier may comprise identifying when the determined measure is below a first threshold or above a second threshold, wherein the threshold(s) may be set with reference to the range of sizes of simplexes (for example at a percentage thereof), or independently therefrom (for example, having been predetermined).

If the simplex does not have a size which is identified as an outlying size, the method proceeds to block 216 and, if i is less than N, i is incremented and the method loops back to block 212 with a new simplex. Once i is equal to N, this indicates that all simplexes have been assessed and the method may terminate. In this way the method iterates through each simplex to check if each simplex comprises an outlier.

If it is identified in block 214 that the size of the simplex is an outlier, the method proceeds to block 218, which comprises determining a dimension of each axis of the simplex. The dimension may be a length, for example the distance between two points forming the particular axis of the simplex. In other examples the distance may be a distance in an axis of color space. For example, for a LAB color space, this may comprise a change in lightness, a change on the green to red axis or a change on the blue to yellow axis. If the color space is an RGB color space, this may comprise a change in Red, Green or Blue values.

In some examples, ‘ramps’ may be constructed by selecting the vertices which are, for a given simplex, at the extremes for each axis. For example, a first ramp may join the two vertices with the highest and lowest R values, a second ramp may join the two vertices with the highest and lowest G values and a third ramp may join the two vertices with the highest and lowest B values. The other vertices may be plotted along these ramps, and the relative spacing between the respective color values may be considered as discussed below.

Block 220 comprises determining if a dimension of an axis is anomalous. It may be determined if the dimension is anomalous by comparing the dimension of the axis to other dimensions of axes in that simplex. It may also be determined that the dimension is anomalous by comparing the dimension to dimensions of other simplexes, for example a dimension which is beyond two standard deviations of the median or above or below a threshold may be considered anomalous. In other examples the dimension may be compared with dimensions along the same axes of adjacent simplexes, and if the dimension is significantly different then it may be considered anomalous.

In the examples of the ‘ramps’ mentioned above, instead of considering the dimension of the axis, the vertices having the greatest relative spacing along at least one ramp may be identified as anomalous. For example, the spacing which is most different to all other spacings may be identified as anomalous.

In some examples, it may be considered that the object or intention may be that the spacing is to be substantially equidistant in colorimetry, wherein colorimetry may for example refer to lightness in one dimension, or full colorimetry in higher dimensions. Therefore, identifying the anomalous spacing may comprise determining which vertices are different from this equidistant spacing. This provides an objective standard against which the ramps in each dimension may be compared, to determine which is anomalous.

Block 222 comprises, when a dimension of an axis is anomalous, determining the new sample generation instruction comprises determining a new sample generation instruction for a color corresponding to a point on the axis having the anomalous dimension. This is intended in effect to ‘move’ the vertex in color space, changing the size of the simplex, such that if the sample were printed using the new sample generation instructions, the color thereof would provide a new point in color space which increased the uniformity of the distribution of the colors of the sample set as a whole.

In one example, if the simplex is shown to be anomalous by being too large, for example based on the size of the simplex, then a dimension thereof (for example, the largest axis thereof) may be identified and reduced, whereas e simplex is shown to be anomalous by being too large, then a dimension thereof (for example, the largest axis thereof) may be identified and enlarged. In some examples, a vertex may be selected to be ‘moved’ on the basis that it is common to edges of the simplex having the longest cumulative length (if the simplex is to be reduced in size) or the shortest cumulative length (if the simplex is to be increased in size). In another example, the vertex selected to be moved may be selected based on the sizes of other simplexes of the vertex. For example, a vertex will generally belong to at least two simplexes and a vertex which belongs to, for example, two simplexes with significantly different sizes may be selected over a vertex belonging to two simplexes with relatively similar size. The targeted position of the vertex may be the position which at least partially equalises the sizes of the simplexes

The new sample generation instructions may be determined based on an interpolation of the sample generation instructions used to generate the color of at least two vertices of at least one simplex. In other examples, the new sample generation instructions may be generated based on color theory. For example, if it is determined that a vertex disrupts an intended distribution as it is ‘too light’, an amount of black may be added to the sample generation instructions which generated that vertex to generate a new sample generation instruction. In examples in which color ramps have been determined, color corrections to provide a more regular spacing of vertices along a given ramp may be determined.

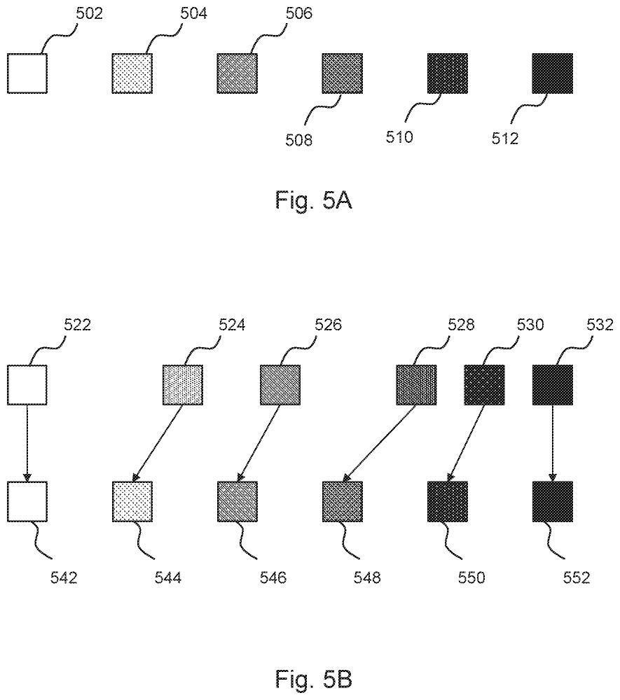

In other examples re-interpolation may be performed to determine the new sample generation instructions. For example, if it is determined that a vertex is ‘too light’ or ‘too dark’, it may be inferred that the vertex is ‘too close’ to some other vertex along a ramp and ‘too far’ from another vertex. To determine the new sample generation instructions, a ‘midpoint’ vertex may be determined using interpolation of the sample generation instructions associated with the vertices which is (at least substantially) equidistant from the other vertexes, thereby generating new sample generation instructions for the vertex which was deemed to be too light/dark. Such a method may be applied to any number of vertexes, for example the samples described in relation to FIG. 5 below.

The method may then loop to block 216 until all simplexes have been reviewed, at which point the method may terminate.

FIG. 3 shows a plurality of points 300 in a color space. In this example the color space is a two dimensional color space, but in other examples the color space may have any number of dimensions, for example it could be the three dimensional CIELAB color space. Each point 302 (only one of which is marked to avoid complicating the Figure) corresponds to a color of a measured color sample, for example as measured in block 204. The spatial distribution of colors in the first color space, based on the data, is assessed to determine if points representing the colors are uniformly distributed in the first color space. A tessellation of simplexes is determined in the color space, the vertices of the simplexes being the points 302 in the color space. In this example the simplexes are triangles as the color space is two dimensional. In higher dimensional spaces the volume of the simplexes is then determined, or in this example the area of the triangles is determined. Simplexes with an abnormally large or small volume, or in this example triangles with an unusually large or small area are identified. In this example one abnormally large triangle 304 is identified and one abnormally small triangle 306 is identified. The abnormal triangles may be identified, for example by identifying when their area varies by a predetermined amount from the median area of triangle, or when it varies by a calculated amount such as two standard deviations from the median. In other examples predetermined thresholds may be used to identify abnormally large or small simplexes, or triangles. In other examples percentiles may be used to identify abnormally large or small simplexes or triangles, for example the largest and smallest 1% may be identified, or the largest and smallest 5% may be identified. When a simplex is identified in this manner, a vertex of the simplex can be identified, for example using the ramps as described above.

The sample generation instructions which provided samples corresponding to a point, or points of the triangles 304, 306 (i.e producing a color at that point in color space) may be modified such that the modified sample generation instructions result in color samples with a more uniform distribution of points in the color space when the color samples are printed and measured. In this particular example, the point which is common to both triangles (or more generally, the point which is common to an anomalously large simplex and the smallest adjoining simplex, or a point which is common to an anomalously small simplex and the largest) adjoining simplex another simplex) may be identified and new sample generation instructions determined therefor, to increase the uniformity of the spatial distribution of color samples efficiently.

In this way, the correspondence of the spatial distribution of colors of a second plurality of color samples generated using the modified set of sample generation instructions to the predetermined spatial distribution may be improved relative to that of the colors of the first plurality of color samples.

FIG. 4 is an example of a method which includes a method of determining a new sample generation. The method of FIG. 4 may be performed for a sample generation instruction which resulted in an unexpected color, for example as identified as described in FIG. 2 or FIG. 3. In the method, the data indicative of a color of each of the first plurality of generated color samples are points in the first color space.

Block 402 comprises for a particular generated color sample, obtaining the data indicative of that color sample and of adjacent color samples in the first color space. Block 404 comprises determining a spacing between the data indicative of the color samples in the first color space, for example using one or more processor. Obtaining the data and determining the spacing may be performed as described above.

Block 406 comprises determining if a color corresponding to the initial sample generation instruction belongs to a predetermined set of protected colors, for example using one or more processor. If the color corresponding to the initial sample generation instruction does not belong to the predetermined set of protected colors the method continues to block 408. If the color corresponding to the initial sample generation instruction does belong to the predetermined set of protected colors then a new sample generation instruction is not generated for that color.

In other words, in this example, determining a new sample generation instruction is conditional on a color corresponding to the initial sample generation instruction not belonging to a predetermined set of protected colors. The set of protected colors may be a predetermined set of colors which should not be modified during a calibration process. For example the predetermined set of protected colors may include a neutral axis of a color space, and/or colors at an extreme of a gamut. In some examples the set of protected colors may be modified, with the condition that the modified color lies along a specific axis. For example in the case of the neutral axis, a correction may be performed with the condition that the corrected vertex also lies along the neutral axis, and not along any other axis. For example, if one edge of a simplex belongs to the neutral axis, then the vertices of that edge may be re-interpolated along the neutral axis. This ensures that the neutral axis is not contaminated with other colors.

Block 408 comprises, based on the determined spacing, generating a new sample generation instruction which provides a more uniform spacing when used to generate the second plurality of color samples. In some examples, this may comprise determining an offset between an expected color sample color and the measured color sample color generated using a first sample generation instruction. A second sample generation instruction which has been tested and which provides a predetermined second color may be identified, wherein the expected color sample color lies between the second color and the measured color. An interpolation of the first and second sample generation instructions may be generated to ‘correct’ the first sample generation instruction, with appropriate weightings given to the first and second sample generation instructions based on their relative distances from the expected color in color space. In some examples, the interpolation may be based on more than two sample generation instructions.

Block 410 comprises printing a printed output using the modified set of sample generation instructions. Using the modified set of sample generation instructions may result in an improvement in the color reproduction of images which are printed after determination of the modified instructions. In some examples, the modified set of sample generation instructions may be used as print instructions in a mapping resource indexed by their color. Instructions for printing intermediate colors may for example be derived (for example interpolated) from the modified set of sample generation instructions.

In FIGS. 5A and 5B the horizontal position of a color sample represents the darkness or lightness of the color. Colors on the left are lighter and colors on the right are darker. The geometric spacing of the color samples is indicative of the difference in color between adjacent colors, i.e. their spatial distribution in color space.

FIG. 5A depicts a plurality of “ideal” generated color samples 502-512. The ideal generated color samples represent the colors expected to be generated using the initial set of sample generation instruction, and may correspond to the colors generated by the sample generation instructions when the output apparatus is new (for example, following an initial calibration and characterisation of the gamut of the output apparatus). In this example the colors range from a white sample 502 through increasing darkness to a black sample 512. Each of the samples is evenly spaced from the other samples in terms of the perceived color difference between a sample and its adjacent sample, represented by even horizontal spacing. For example the first color sample 502 is white, the second color sample 504 is light grey, the third color sample 506 and the fourth color sample 508 are intermediate greys, the fifth color sample 510 is a dark grey and the sixth color sample 512 is black. Each of the samples 502-512 are spaced in a color space such that they are perceptually uniform, i.e. the first color sample 502 and the second color sample 504 are the same perceived color distance apart, the second color sample 504 and the third color sample 506 are the same perceived color distance apart, and so on. Such a plurality color samples may be displayed or printed by an output device for use in calibration of that device. If, during a subsequent assessment, the output appeared as depicted in FIG. 5A, this would indicate that the device is correctly calibrated as the colors are uniformly spaced in the color space.

The first row of color samples 522-532 depicted in FIG. 5B are indicative of color samples generated using the same initial sample generation instructions as used to generate the samples depicted in FIG. 5A, but are generated after some time has passed and there has been a drift in the apparatus such that the generated colors do not correspond to the expected generated colors. As can be seen, the color samples 522-528 are spaced more widely and color samples 528-532 are spaced more closely so that the color samples do not conform to the intended distribution (i.e. in this example, are not uniformly distributed throughout the color space). If the apparatus were used to generate an output, the generated output may not accurately reflect the colorimetry intended for the output image. Furthermore the portions of the color space representing lighter colors would be sampled at a lower resolution than the portions of the color space representing the darker colors. As the samples may be used as the basis for interpolating color generation instructions, an under-sampled region may lead to greater uncertainty in interpolation than a more densely sample region.

The generated color samples 522-532 can be measured, and based on the measurements, the sample generation instructions may be modified such that when the modified sample generation instructions are used to generate a second set of color samples 542-552, the second set of color samples are evenly distributed in the color space. As can be seen the second set of color samples 542-552 generated by the modified sample generation instructions are evenly spaced and therefore correspond to the expected generated output colors. In particular, the newly generated print instructions may be generated so as to color-shift the color samples generated thereby relative to the instructions they replace. This color shift may be along an axis in color space (in this example, a shift in the ‘lightness’ axis. The new instructions in some examples may be determined so as to linearize the distribution of samples in at least one axis of color space. In some examples, a correction to an existing instruction may be determined to correct a color in at least one axis, for example to increase or reduce lightness so that a new color sample will be closer to an intended point on the lightness axis than the measured color sample.

Therefore the modified instructions will produce improved image quality in the output they generate relative to the initial instructions. The sample generation instructions may for example be modified as described in relation to FIG. 4.

In some examples, a new color mapping resource may be generated based on a subsequent set of samples generated using any new sample generation instructions. For example, the modified set of sample generation instructions may provide nodes in a color mapping resource, from which new color generation instructions may be generated, for example based on interpolation of the sample generation instructions.

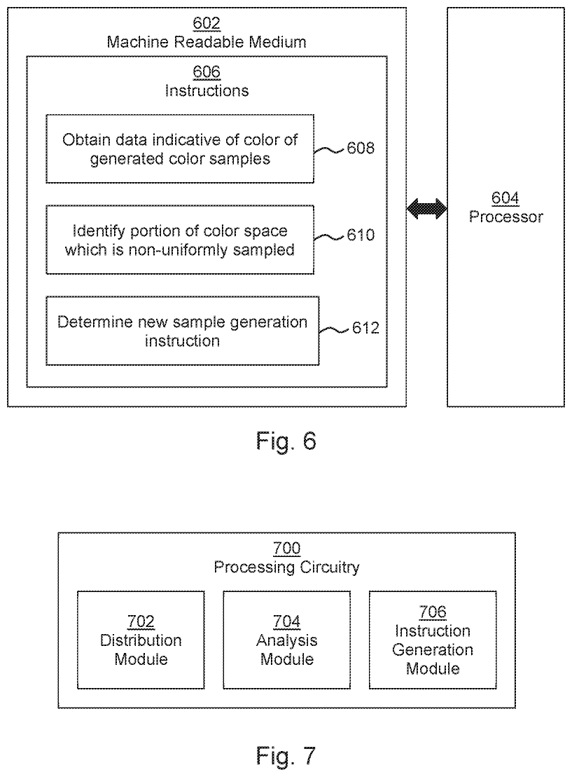

FIG. 6 shows an example of a machine-readable medium 602 associated with a processor 604. The machine-readable medium 602 stores instructions 606 which when executed by a processor 604 cause the processor 604 to carry out tasks. In this example, the instructions 606 comprise instructions 608 to cause the processor 604 to obtain data indicative of a color of each of a first plurality of generated color samples, wherein the color samples are generated using an initial set of sample generation instructions.

The machine-readable medium 602 further comprises instructions 610 to cause the processor 604 to identify a portion of the color space which is non-uniformly sampled by the colors of the generated color samples.

The machine-readable medium 602 further comprises instructions 612 to cause the processor 604 to determine a new sample generation instruction corresponding to the identified portion, the new sample generation instruction being to replace a sample generation instruction in the initial set of sample generation instructions to determine a modified set of sample generation instructions, wherein the new sample generation instruction is generated to increase the uniformity of a distribution of colors in a second plurality of color samples generated using the modified set of sample generation instructions.

In some examples, the machine-readable medium 602 comprises instructions to cause the processor 604 to carry out any or any combination of the blocks of FIG. 1, 2, or block 402 to 408 of FIG. 4.

FIG. 7 shows an example of a processing circuitry 700, The processing circuitry 700 comprises a distribution module 702 to determine a distribution of colors of generated color samples in a first color space, wherein the color samples are generated using a set of sample generation instructions.

The processing circuitry 700 further comprises an analysis module 704 to identify anomalies (for example, non-uniformities) in the distribution of the colors of the generated color samples. In other examples, the analysis module 704 may identify non-conformity between the distribution of the colors of the generated color samples in a color space and a predetermined distribution as discussed above as an anomaly.

The processing circuitry 700 further comprises an instruction generation module 706 to generate a new sample generation instruction when the determined distribution comprises an anomaly. In some examples, creating a new sample generation instruction comprises modifying a sample generation instruction of the sample generation instructions which contributes to the non-uniformity to increase the uniformity of the distribution of colors of color samples printed using the set of sample generation instructions. In other examples, the instruction generation module 706 may generate a new sample generation instruction when the determined distribution does not conform to a predetermined distribution, wherein creating a new sample generation instruction comprises modifying a sample generation instruction of the sample generation instructions which contributes to the non-conformity to increase the conformity of the distribution of colors of color samples printed using the set of sample generation instructions to the predetermined distribution.

In some examples the processing circuitry 700 is coupled to a printing device. For example the processing circuitry may be a general purpose computer coupled to the printing device, and may be coupled directly to the printing apparatus or may be coupled via a network. In other examples the processing circuitry may be integral with the printing apparatus. In some examples, the processing circuitry 700 may carry out any or any combination of the blocks of FIG. 1, 2, or block 402 to 408 of FIG. 4.

Examples in the present disclosure can be provided as methods, systems or machine readable instructions, such as any combination of software, hardware, firmware or the like. Such machine readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
obtaining, at a processor, data indicative of a color of each of a first plurality of generated color samples, wherein the color samples are generated using an initial set of sample generation instructions; and
determining, by a processor, if a spatial distribution of the colors of the generated color samples corresponds to a predetermined spatial distribution in a first color space,
wherein, when the spatial distribution of the colors of the generated color samples does not correspond to the predetermined spatial distribution the method further comprises:
determining, by a processor, a new sample generation instruction, the new sample generation instruction being to replace an initial sample generation instruction in the initial set of sample generation instructions to determine a modified set of sample generation instructions, wherein the new sample generation instruction is generated to increase a correspondence of the spatial distribution of colors of a second plurality of color samples generated using the modified set of sample generation instructions to the predetermined spatial distribution.

2. A method as claimed in claim 1, wherein determining if the spatial distribution of colors of the generated color samples corresponds to a predetermined spatial distribution in a first color space comprises:
determining a measure describing a spatial uniformity of the data indicative of the color of each of the first plurality of generated color samples; and
identifying an outlier in the determined measure.

3. A method as claimed in claim 2, wherein identifying an outlier comprises:
identifying when the determined measure varies more than one standard deviations from a median; or
identifying when the determined measure is below a first threshold or above a second threshold.

4. A method as claimed in claim 2 wherein determining the measure describing the spatial uniformity comprises:
determining a plurality of simplexes in the first color space, vertices of the simplexes defined by the obtained data indicative of the color of each of the first plurality of generated color samples; and
determining a size of each simplex,
wherein the measure describing spatial uniformity is the determined size.

5. A method as claimed in claim 4, further comprising for each simplex comprising an outlier:
determining a dimension of each axis of the simplex;
determining if a dimension of an axis is anomalous; and
when a dimension of an axis is anomalous, determining the new sample generation instruction comprises determining a new sample generation instruction for a color corresponding to a point on the axis having the anomalous dimension.

6. A method as claimed in claim 1 wherein obtaining data indicative of a color of each of a first plurality of generated color samples comprises:
printing a calibration pattern comprising each of the first plurality of generated color samples; and
measuring each color sample in the printed calibration pattern to obtain the data.

7. A method as claimed in claim 6 wherein printing the printed calibration pattern comprises printing patches of color representative of a portion of a gamut of a printing apparatus.

8. A method as claimed in claim 1 wherein the predetermined spatial distribution in the first color space is a uniform distribution of points in the first color space and is representative of a gamut or a portion of a gamut.

9. A method as claimed in claim 8 wherein determining if the spatial distribution of the colors of the generated color samples corresponds to the predetermined spatial distribution in the first color space comprises:
determining the spatial distribution of colors in the first color space based on the data; and
identifying if points representing the colors are uniformly distributed in the first color space.

10. A method as claimed in claim 1 further comprising:
printing a printed output using the modified set of sample generation instructions.

11. A method as claimed in claim 1 wherein the data indicative of a color of each of the first plurality of generated color samples are points in the first color space; and wherein determining a new sample generation instruction comprises:
for a particular generated color sample, obtaining data indicative of that color sample and of at least one adjacent color sample in the first color space;
determining a spacing between the data indicative of the color samples in the first color space; and
based on the determined spacing, generating a new sample generation instruction which provides a more uniform spacing when used to generate the second plurality of color samples.

12. A method as claimed in claim 1 wherein determining a new sample generation instruction is conditional on a color corresponding to the initial sample generation instruction not belonging to a predetermined set of protected colors.

13. A machine-readable medium storing instructions which when executed by a processor cause the processor to:
obtain data indicative of a color of each of a first plurality of generated color samples, wherein the color samples are generated using an initial set of sample generation instructions;
identify a portion of a color space which is non-uniformly sampled by the colors of the generated color samples; and
determine a new sample generation instruction corresponding to the identified portion, the new sample generation instruction being to replace a sample generation instruction in the initial set of sample generation instructions to determine a modified set of sample generation instructions, wherein the new sample generation instruction is generated to increase a uniformity of a distribution of colors in a second plurality of color samples generated using the modified set of sample generation instructions.

14. Processing circuitry comprising:
a distribution module to determine a distribution of colors of generated color samples in a first color space, wherein the color samples are generated using a set of sample generation instructions;
an analysis module to identify anomalies in the distribution of the colors of the generated color samples; and
an instruction generation module to generate a new sample generation instruction when the determined distribution comprises an anomaly, wherein creating a new sample generation instruction comprises modifying a sample generation instruction of the sample generation instructions which contributes to the anomaly.

15. Processing circuitry as claimed in claim 14 wherein the processing circuitry is coupled to a printing device.
